(19) United States
(12) Patent Application Publication
(10) Pub. No.: US 2009/0017871 A1
(43) Pub. Date: Jan. 15, 2009

(54) Control for the display device for a communication terminal

(76) Inventor: Jurgen Brieskorn, Geltendorf (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/664,733

(22) PCT Filed: Feb. 22, 2006
(86) PCT No.: PCT/EP06/60166

§ 371 Date: Apr. 5, 2007

(30) Foreign Application Priority Data
Mar. 29, 2005 (DE) 10 2005 014 675.9

(51) Int. Cl. H04B 1/38; H04Q 5/22

(52) U.S. Cl. 455/566; 340/10.6

(57) ABSTRACT

There is described a method for operating a device comprising a display device, a communication device and a communication system. According to said method, the display device is activated once a user enters a near field of the device, and the display device is deactivated once a user leaves the near field of the device. The display device comprises OLEDs or other components that have a short service life and/or a high power requirement. Activation and/or deactivation are controlled by a transponder, e.g. an RFID-TAG to be carried by the user, which responder is detected in the near field of the device. Temporary deactivation of the display device can prolong the service life of the display device and/or save power and the use of contactless RFID-TAGs increases ease of operation. The technology can also be used for other purposes, e.g. user authorization.

### CROSS REFERENCE TO RELATED APPLICATIONS

This application is the US National Stage of International Application No. PCT/EP2006/060166, filed Feb. 22, 2006 and claims the benefit thereof. The International Application claims the benefits of German application No. 10 2005 014 675.9 DE filed Mar. 29, 2005, both of the applications are incorporated by reference herein in their entirety.

### FIELD OF INVENTION

The invention relates to a method for operation of an appliance having a display device, to a communication terminal having a display device, and to a communication arrangement.

### BACKGROUND OF INVENTION

Modern communication terminals generally have display devices (displays) by means of which the user can be offered a wide range of information, for example about communication partners, callers, call data, names, the date, the time, etc. Furthermore, the display devices are also used for interactive user guidance, for example by displaying selection menus.

The display devices of conventional communication terminals are generally in the form of liquid crystal displays (LCD) which on the one hand have an extremely long life and on the other hand consume very little power. In this case, the liquid crystal displays are generally operated all the time, because there is no need to switch off the display device when it is not being used, either because of the life or because of the power consumption.

Liquid crystal displays are subject to the disadvantage that they are passive, that is to say they are not self-illuminating and therefore must be combined with an external light source at least in poor lighting conditions (at dusk and when it is dark). These external light sources—often also referred to as a “backlight” (background lighting)—are frequently in the form of LEDs (light-emitting diodes) or miniature fluorescent tubes. At least in the case of appliances operated by batteries or rechargeable batteries, the power consumption of these light sources has a considerable influence on the usage time of the appliance, so that, for example, in mobile telephones, the light source is switched on only when a user is operating a key, and the light source is switched off again when the user is “inactive” for a relatively long time (for example after 20 seconds without a key being pressed).

Thus, while the light source which is associated with the display devices in the case of mobile communication terminals is switched on and off controlled by key inputs by the user or by “external events” (incoming call, appointment signal, etc.) in the case of communication terminals that are not mobile (for example “table-top telephones”), there is either no need for a light source for the display device because the lighting situation in offices and at other points of use is generally sufficient, or else a permanently operated light source is not disadvantageous because the power consumption of a light source such as this need not be supplied from a battery or rechargeable battery.

In the case of appliances with display devices, for example the communication terminals which have been mentioned, display devices with organic light-emitting diodes, so-called OLEDs, are increasingly being used rather than liquid crystal displays. Organic light-emitting diodes are active display elements, that is to say they are self-illuminating, and thus do not require any external light source. However, one disadvantage of this technique is that OLEDs have only a restricted life. Display devices which comprise OLEDs therefore need to be deactivated not only because of the power consumption when they are not being used (for example in mobile communication terminals) but also because of their limited life, which also relates to non-mobile communication terminals. While many users of mobile communication terminals are familiar with the need to switch the display device on and off, this frequently leads to irritation in the case of non-mobile communication terminals, because, on the one hand, additional process steps, specifically switching on the display device, are necessary, and on the other hand the display devices of these appliances cannot be read all the time, in contrast to normality.

### SUMMARY OF INVENTION

An object of the invention is thus to make the operation of appliances with display devices more economic and more convenient.

The object is achieved by a method and by apparatus as claimed in the independent claims.

The object envisages a method for operation of an appliance having a display device, with the display device being activated when a user is located in a near field of the appliance, and with the display device being deactivated when no user is located in the near field of the appliance.

An achievement of the object also envisages a communication terminal having a display device, with the display device comprising organic light-emitting diodes (OLEDs), and with the communication terminal comprising a receiver for RFID signals and a control device, with the control device being designed in such a way that the display device is active when a—preferably passive, that is to say not requiring its own power supply—RFID transponder is located in the reception area of the receiving device.

The object is also achieved by the provision of a communication arrangement having a communication terminal as claimed in one of patent claims 6 to 10, with a radio-frequency identification transponder being provided which can be carried by the user and in which a user identification for the user is stored, and with the communication terminal being designed to activate and/or deactivate functions as a function of the user identification which can be received from the radio-frequency identification transponder in the near field of the communication terminal.

The use of the method makes it possible to operate a display device only when it is actually required, thus saving resources. This advantageously relates on the one hand to energy saving and on the other hand to lengthening the life, which is particularly important when the display device comprises components (for example organic light-emitting diodes) which are subject to increased wear.

A communication terminal according to the invention accordingly has a reduced power consumption as well as an increased life (MTBF=Mean Time Between Failure). If the communication terminal according to the invention is operated by means of batteries or rechargeable batteries, the embodiment according to the invention ensures a longer life before the battery needs to be replaced, or before the rechargeable batteries need to be recharged.

In the case of the communication arrangement according to the invention, the reduced power consumption, the longer life of the display device and the capability to prevent unauthorized, improper use of the communication terminal as such, or of individual functions of the communication terminal, in a simple and user-friendly manner (preferably without contact and without any additional manual operating step) should be stressed as being particularly advantageous.

Advantageous refinements of the invention are specified in the dependent claims, in which case the features and advantages of the method also apply in the same sense to the communication terminal and to the communication arrangement and in which case, conversely, the particular features and advantages of the communication terminal and of the communication arrangement are also applicable in the same sense to the method according to the invention.

If the identity of the user is recorded and his authorization is checked for control of the activation and/or deactivation, on the one hand it is possible to reduce the use of the appliance by unauthorized users, while on the other hand the appliance can also advantageously be operated in those environments in which a plurality of potential users are located in the near field of the appliance. In this case, the display device is activated only when at least one of the recorded potential users is actually authorized to use that appliance.

The use of an appliance according to the invention, for example of a communication terminal, is accepted particularly well by the users when the use of the method does not require any additional process steps. This is the case when a radio-frequency identification transponder, for example a so-called RFID-TAG, which is carried by the user is used for recording the presence of the user in the near field and/or for recording the identity of the user by the appliance. On the one hand, the presence of the user in the viewing area of the display device is thus recorded without contact being made, and on the other hand this is done automatically, provided that the user is carrying the appropriate RFID-TAG with him.

The method can be used particularly advantageously in communication terminals on the one hand because the display device of a communication terminal should be active whenever the user has the communication terminal in his field of view, that is to say close to him, and on the other hand also because long pauses in use of the display device are possible. In the case of office communication appliances by way of example, this is the case during pauses in the work, at night, at weekends and while on vacation. A communication terminal which uses the method according to the invention is in this case reliably switched to a so-called standby state during pauses in use such as these. In this case, it has been found to be particularly advantageous, for example in the case of communication terminals which are used in offices, for the RFID-TAG to be combined with objects which are carried by a user (for example an employee) in any case, for example the company ID card.

It is particularly advantageous for the display device to use organic light-emitting diodes, so-called OLEDs. Display devices with OLEDs are mechanically flexible, are physically small and are easily legible. The disadvantages of OLED technology, that is to say the greater power consumption than LED display devices and the shorter life are overcome by the use of methods according to the invention to such an extent that the OLEDs can be used in a worthwhile manner even in appliances which are operated all the time, such as communication terminals.

Appliances, in particular communication terminals, in general already have existing control devices which, inter alia, control the function of the display device. It is advantageous for the control device to be adjustable such that the display device is active either only when a user is located in the near field of the relevant appliance, or else the deactivation or activation of the display device is made dependent on whether a user of the appliance is moving away from it or is approaching it. While, in the former case, a specific area (near field) around the appliance is monitored for the presence of the user or for an RFID-TAG associated with him, the movement of the user is recorded in the latter case.

If the display device can be activated manually and/or can be deactivated manually, a user can use the appliance even when he has, for example, forgotten his RFID-TAG. The appliance can thus be operated at any time, for example for making an emergency call.

The technical devices which are required for control of the display device can also be used in other ways without any particular additional complexity, for example by designing the control device to pass on the information about the recorded user to a device for working-time recording. Further application examples are the control of room lighting, the control of heating/air-conditioning/ventilation appliances or the like. In addition to such “external” appliances, the information about the identity of the user can also be used to enable selected functions of the appliance, for example for the authorization to make telephone calls to incur a cost.

### BRIEF DESCRIPTION OF THE DRAWINGS

Exemplary embodiments of the method according to the invention will be explained in the following text with reference to the drawings. In this case, exemplary embodiments of communication terminals and communication arrangements according to the invention will be explained at the same time.

In the figures:

FIG. 1 shows a schematic illustration of an appliance with a display device and of a radio-frequency identification transponder in its near field, and

FIG. 2 shows the appliance, in which in each case one radio-frequency identification transponder is being moved towards the appliance and away from the appliance.

### DETAILED DESCRIPTION OF INVENTION

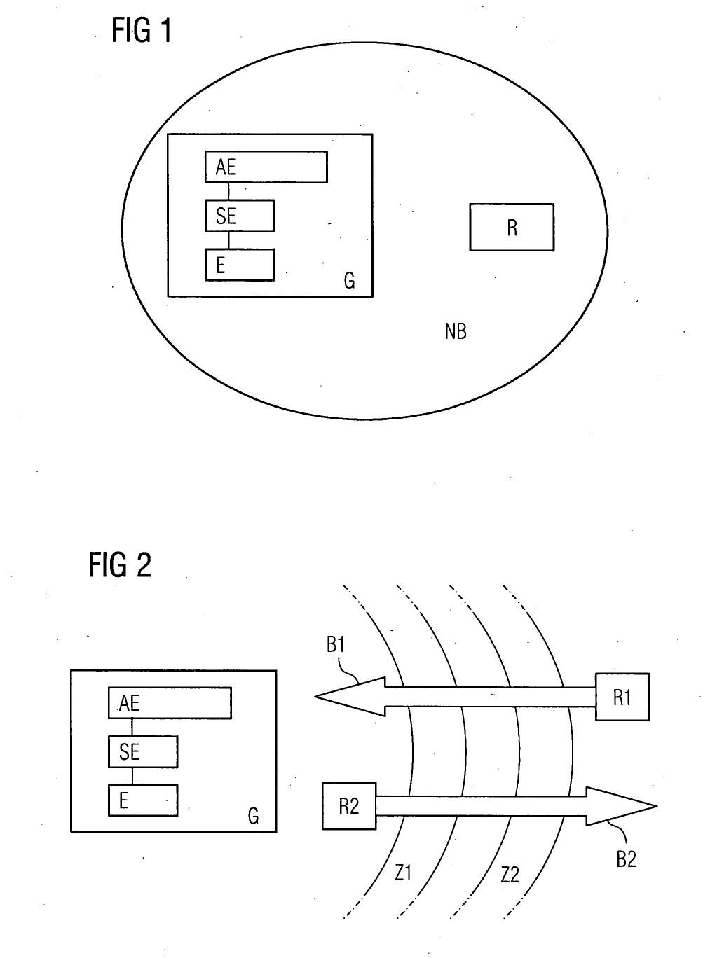

As one example of an appliance, FIG. 1 shows a communication terminal G which has a display device AE, a control device SE and a receiver E. The near field NB of the communication terminal G is located around the communication terminal G, with the near field in this exemplary embodiment being identical to the reception area of the receiving device E. In this exemplary embodiment, the near field NB is an area with a radius of several meters around the communication terminal G, with this distance being at least as large as the maximum reading distance for the display device AE. A user who is carrying a radio-frequency identification transponder (“RFID-TAG”) R is located in the near field of the communication terminal G.

In this case, the display device AE comprises a large number of organic light-emitting diodes (so-called OLEDs) which are combined to form an alpha numeric display in a film structure. Other display devices may, of course, also be used instead of the OLED-based technique.

The receiving device E is designed in such a way that it transmits an electromagnetic pulse at regular time intervals, for example once per second, in order to check all the RFID-TAGs R in the near field NB, that is to say in its reception area. The RFID-TAG R responds to each of these pulses with a data record which contains a user identification for the user with whom the RFID-TAG R is associated. The data record is received by the receiving device E and is passed to the control device SE. The control device SE compares the user identification of the data record with a stored list of authorized users of the communication terminal G and on the one hand confirms whether the user of the RFID-TAG R which has responded is in fact a permitted user of the communication terminal G, and on the other hand which functions this identified user may carry out.

In the present exemplary embodiment, it is now confirmed that the RFID-TAG is associated with a permitted user, so that the control device SE activates the display device AE. In this case, the communication terminal G has a menu-controlled user interface, so that the menu guide offers the identified user only those functions which he is authorized to make use of.

Further actions can be programmed in the control device SE, and are carried out when a user is recorded. These include, for example, call forwarding being carried out in a communication node (not illustrated) on which the communication terminal G is operated, or else a time recording system being informed of the presence of the user.

The maximum operating time of the OLED display elements used in the exemplary embodiment is limited, so that it must be expected that individual display elements will fail even after one or two years, depending on the selected brightness level, when the display device is operated continuously. The use of the display device only when required makes it possible to lengthen the “life” of the display device to an acceptable level.

The exemplary embodiment is not restricted to display devices “which are subject to wear” but can alternatively also be used for other display devices, such as LCD displays or TFT displays with background lighting. In the case of these display devices, the primary factor is not to extend the useful life of the appliance but to save energy by temporarily switching off the display device and its background lighting.

In a corresponding manner to the activation of the display device AE, the display device AE is deactivated when no RFID-TAG R of a registered user is recorded over a relatively long time period, for example of one minute. As an alternative to switching the display device on and off automatically and automatically enabling and inhibiting functions by means of the RFID-TAG R, it is also possible to use other sensors, for example infrared motion detectors. Furthermore, manual activation and deactivation of the display device and/or of the functions of the communication terminal G are/is also possible in order to allow the appliance to be operated even in situations in which the RFID-TAG is not being carried, or the registered users do not all have an RFID-TAG R. This means, for example, that it is also possible to make an emergency call from an otherwise inhibited communication terminal G.

As an alternative to the “selective” activation described here, in which the user identification provided in the RFID-TAG R is evaluated, the display device AE can also be activated whenever any given RFID-TAG R is located in the reception area of the receiving device E.

While, in the case of the preferred embodiment described here, the receiving device E and the control device SE are components of the same appliance (communication terminal G) which has the display device AE that is to be controlled, the components may, of course, also be arranged in different appliances which are networked with one another.

A “non-compact” configuration such as this may be advantageous in particular in the case of the embodiment discussed with reference to FIG. 2. FIG. 2 shows the communication terminal G which has already been described with reference to FIG. 1. In contrast to the already described exemplary embodiment, the presence or absence of RFID-TAGs in the near field of the communication terminal G is not detected in this case, but a check is carried out to determine whether an RFID-TAG R1, R2 is moving towards the communication terminal G,—as is indicated by the arrow B1 for the RFID-TAG R1 in FIG. 2—or whether a user with an RFID-TAG is moving away from the communication terminal G. The latter case is illustrated by the arrow B2 for the RFID-TAG R2. In FIG. 2, two zones Z1, Z2 are arranged—in this case essentially concentrically around the communication terminal G—with the zone Z1 being located closer to the communication terminal G than the zone Z2. The zones Z1, Z2 are in this case shown separately from one another, although they may also be directly adjacent or may merge into one another. The receiving device E can distinguish whether an RFID-TAG R1, R2 is located in zone Z1 (or closer) or in zone Z2 (or further away). As in this exemplary embodiment, this distinction may be drawn on the basis of the different signal energy on reception of the data records. Alternatively, the receiving device E may also have different receiver circuits and/or antennas at different locations, for example in an axis corridor to a room, so that in situations such as these the location of the RFID-TAG R1, R2 can be determined by the receiving antenna or receiving unit. Depending on the sequence in which the RFID-TAG R1, R2 passes through the zones Z1, Z2, the receiving device E and the control device SE decide whether the user with the RFID-TAG R1, R2 is approaching or is moving away. The display device, and possibly predefined functions of the communication terminal G, are activated when the corresponding RFID-TAG R1, R2 is approaching the communication terminal G, and are conversely deactivated when moving away.

If receiving devices with a low transmission and reception power are used, their “range” that is to say their coverage area and thus the near field, is relatively small. A very large number of receiving devices E are therefore required in particular in relatively large rooms, for example in open-plan offices, in order to control the display devices of a large number of appliances. On the other hand, even large rooms often have only a small number of access facilities (lifts, corridors), so that, particularly in the case of an arrangement shown in FIG. 2, a small number of receiving devices is sufficient to control a large number of appliances. This small number of receiving devices is for this purpose advantageously connected to one central node, for example a communication system, with this central node controlling the display devices of the various appliances and, possibly, also the available functions of these appliances, from a central point via a network (LAN, WLAN, telephone network). In cases such as these, a central node is arranged between the receiving device E and the control device SE.

It is not absolutely essential to provide separate or specific RFID-TAGs for the method of operation of the described appliances. In fact, in one advantageous refinement of the appliances, already existing RFID-TAGs can be made known to the control device SE. For example, a large number of company employee ID cards already have RFID-TAGs for non-contacting control of automatic doors and, of course, these can also be used to control the communication terminals. Car keys, wrist watches and similar objects which are generally carried in any case by users are in principle suitable for having RFID-TAGs and thus for providing automatic control of display devices and other functions of communication terminals and other appliances.

1-11. (canceled)

12. A method for operating a system having a display device, comprising:
providing organic light-emitting diodes for the display device;
activating the display device when a user nears a specific area around the system; and
deactivating the display device when the user leaves the specific area of the system.

13. The method as claimed in claim 12, wherein the specific area is a near field.

14. The method as claimed in claim 12, wherein the system has a communication terminal and the near field has a radius of several meters around the communication terminal being as large as a maximum reading distance of the display device.

15. The method as claimed in claim 12, wherein an identity of the user is recorded and an authorization of the user is checked to control the activation or deactivation of the display device.

16. The method as claimed in claim 15, wherein a radio-frequency identification transponder carried by the user is recorded by the appliance to record the user in the specific area.

17. The method as claimed in claim 16, wherein an identity of the user is recorded based upon the radio-frequency identification transponder carried by the user.

18. The method as claim 17, wherein the appliance is a communication terminal.

19. A method for operating an appliance having a display device, comprising:
providing organic light-emitting diodes for the display device;
activating the display device when an RFID-TAG is moved towards the display device; and
deactivating the display device when the RFID-TAG is moved away from the display device.

20. The method as claimed in claim 18, wherein a first zone and a second zone are arranged around the display device, wherein the first zone is closer to the display device than the second zone and determining depending on the sequence in which the RFID-TAG passes through whether the RFID-TAG is moved towards the display device or is moved away from the display device.

21. A communication terminal, comprising:
a display device with organic light-emitting diodes;
a receiving device for a radio-frequency identification transponder having an reception area; and
a control device to evaluate the radio-frequency identification data recorded by the receiving device and to control the display device by switching on the display device if the radio-frequency identification transponder is recorded in the reception area.

22. The communication terminal as claimed in claim 21, wherein the receiving device records the radio-frequency identification transponder approaching and/or being moved away from the communication terminal, and
the control device activates the display device when the radio-frequency identification transponder is approaching, and deactivates the display device when the radio-frequency identification transponder is moved away from the communication terminal.

23. The communication terminal as claimed in claim 22, wherein the display device is activated manually.

24. The communication terminal as claimed in claim 22, wherein the display device is deactivated manually.

25. The communication terminal as claimed in claim 22, wherein the control device distinguishes between different users, wherein the control device associates different authorizations with different users, and wherein the control device activates the display device of the communication terminal only if the identified user is appropriately authorized.

26. The communication terminal as claimed in claim 25, wherein the control device passes on the information about the recorded user to a device for working-time recording.

27. A communication system, comprising:
a radio-frequency identification transponder having a user identification stored;
a communication terminal having:
a display device with organic light-emitting diodes,
a receiving device for the radio-frequency identification transponder, having an reception area,
a control device to evaluate the radio-frequency identification data recorded by the receiving device and to control the display device by switching on the display device if the radio-frequency identification transponder is recorded in the reception area, and
a storage device to store the user identification; and
activation or deactivation of functions of the communication terminal based upon the user identification received from the radio-frequency identification transponder in a specific area of the communication terminal.
